(19) United States
(12) Patent Application Publication
(10) Pub. No.: US 2011/0310448 A1
(43) Pub. Date: Dec. 22, 2011

(54) METHOD FOR CALCULATING COMPUTER GENERATED HOLOGRAM USING LOOK-UP TABLE AND APPARATUS THEREOF

(75) Inventors: Eun-Soo Kim, Seoul (KR); Seung-Cheol Kim, Seoul (KR)

(73) Assignees: Eun-Soo Kim, Seoul (KR); Kwangwoon University Research Institute for Industry Cooperation, Seoul (KR); Seung-Cheol Kim, Seoul (KR)

(21) Appl. No.: 12/817,717

(22) Filed: Jun. 17, 2010

(51) Int. Cl. G03H 1/08

(52) U.S. Cl. 359/9

(57) ABSTRACT

A method of calculating a computer generated hologram (CGH) using a look-up table and an apparatus thereof are disclosed. The method in accordance with an embodiment of the present invention can include calculating one principal fringe pattern for points of a target object that are separated by a same distance from a reference point of a hologram plane, writing the principal fringe pattern in the look-up table in accordance with a distance between the points of the target object and the reference point, calculating computer-generated hologram information by shifting the principal fringe pattern to the points of the target object located on a same plane, and playing back a three-dimensional image by using the computer-generated hologram information.

### BACKGROUND

1. Technical Field

The present invention is related to a method of calculating a hologram, more specifically to a method of calculating a computer generated hologram using a look-up table, and an apparatus thereof.

2. Description of the Related Art

Studies are underway to develop 3-dimensional images and image playing back technologies, and it is expected that a next generation display as a real-like image media that can increase the level of visual information higher is about to be developed. Moreover, 3-dimensional images are real-like and more natural than 2-dimensional images, and thus there has been an increasing demand for 3-dimensional images.

Among these 3-dimensional image technologies, holography is a technique that allows an observer to view a virtual 3-dimensional image when a recorded image (hologram) is viewed by a particular distance from the front surface of the recorded image.

The holographic method allows a hologram manufactured by a laser to appear three dimensional viewed by human eyes without any special observation devices. Accordingly, the holographic method is excellent in 3-dimensionality and has been regarded as one of the most attractive approaches for creating the most authentic illusion of observing volumetric objects without human fatigue.

So far, some approaches for generation of digital hologram patterns have been suggested. One of them is the ray-tracing method, which is commonly used to calculate diffraction of light when calculating a hologram pattern. In this method, a target object is regarded as a set of points, and hologram patterns for all points of the target object is calculated and added together. However, this method suffers from the computational complexity because it requires one-by-one calculation of the fringe pattern per image point per hologram sample, making it difficult for real-time playing back.

To overcome this problem, a look-up table (LUT) method that allows a real-time processing was proposed. In this method, all fringe patterns corresponding to point source contributions from each of the possible locations in an image volume are precalculated and stored in the LUT. However, this method also involves a great number of fringes as the object becomes bigger, and thus the look-up table becomes too big.

### SUMMARY

The present invention provides a method for calculating a computer-generated hologram using a look-up table that allows real-time playing back for holograms, and an apparatus thereof.

The present invention provides a method for calculating a computer-generated hologram using a look-up table that requires small memory capacity when playing back holograms, and an apparatus thereof.

Other problems that the present invention solves will become more apparent through the following embodiments described below.

An aspect of the present invention provides a method of calculating a hologram using a look-up table by a computer-generated hologram calculating apparatus. The method in accordance with an embodiment of the present invention can include calculating one principal fringe pattern for points of a target object that are separated by a same distance from a reference point of a hologram plane, writing the principal fringe pattern in the look-up table in accordance with a distance between the points of the target object and the reference point, calculating computer-generated hologram information by shifting the principal fringe pattern to the points of the target object located on a same plane, and playing back a three-dimensional image by using the computer-generated hologram information.

Another aspect of the present invention provides a computer-generated hologram calculating apparatus using a look-up table. The apparatus in accordance with an embodiment of the present invention can include a principal fringe pattern calculating unit, which calculates one principal fringe pattern for points of a target object that are separated by a same distance from a reference point of a hologram plane, a look-up table, which writes the principal fringe pattern in the look-up table in accordance with a distance between the points of the target object and the reference point, a CGH generating unit, which calculates computer-generated hologram information by shifting the principal fringe pattern to the points of the target object located on a same plane, and a CGH pattern reconstructing unit, which plays back a three-dimensional image by using the computer-generated hologram information.

The principal fringe pattern can be calculated by using the following equation.

$$T ( x , y , {x}_{p} , {y}_{p} , {z}_{p} ) = \frac{1}{{r}_{p}} cos [ {kr}_{p} + kx sin {θ}_{R} + {Φ}_{p} ]$$

Here, T is the principal fringe pattern, (xp, yp, zp) is a coordinate of a pth point of the target object, rₚ is a distance between the pth point of the target object and the reference point (x, y, 0), k is defined as k=2π/λ, in which λ is the free space wavelength of the light, θ_{R} is an angle between a reference beam and an object beam, and Φₚ is a phase value of an object beam of the pth point of the target object.

The computer-generated hologram information can be calculated by using the following equation.

$$I ( x , y ) = {\sum }_{p = 1}^{N} {a}_{p} T ( x - {x}_{p} , y - {y}_{p} , {z}_{p} )$$

Here, I is the computer-generated hologram information, aₚ is an intensity value of the object beam of the pth point of the target object, and N is the number of points of the target object.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates a method of obtaining 3-dimensional information using holography in accordance with an embodiment of the present invention.

FIG. 2 illustrates a method of calculating a computer generated hologram using a look-up table in accordance with an embodiment of the present invention.

FIG. 3 illustrates a hologram pattern formed by shifting a reference fringe pattern in accordance with an embodiment of the present invention.

FIG. 4 illustrates an input image and a depth image used for a method of calculating a computer generated hologram using a look-up table in accordance with an embodiment of the present invention.

FIG. 5 compares a hologram pattern in accordance with an embodiment of the present invention and a hologram pattern in accordance with the related art.

FIG. 6 compares an image played back in accordance with an embodiment of the present invention and an image played back in accordance with the related art.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Certain embodiments of the present invention will be described below in detail with reference to the accompanying drawings. Those components that are the same or are in correspondence are rendered the same reference numeral regardless of the figure number, and redundant descriptions are omitted. Before describing certain embodiments of the present invention, a general principle and a system for obtaining 3-dimensional information using holography will be first described below.

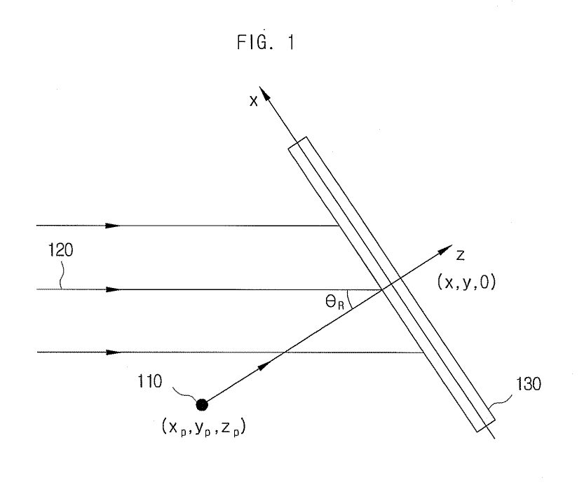

FIG. 1 shows a method of obtaining 3-dimensional information using holography in accordance with an embodiment of the present invention.

In holography, a simple hologram can be made by superimposing two beams from the same laser beam from a laser. One hits a screen normally, and the other one hits a target object. Here, the beam hitting the screen normally is referred to as a reference beam (the reference beam 120), and the beam hitting the target object is referred to as an object beam.

Since the object beam is a beam that reflects from the surface of the target object, the relative phase between the two beams varies, depending on the distance between the surface of the object and the screen. Here, the reference beam, which is not deformed, and the object beam interfere with each other to form an interference pattern, and then the interference pattern is stored in the screen. The recorded film, in which the interference pattern is stored, is referred to as a hologram.

A computer generated hologram (hereinafter, referred to as CGH) pattern is digitally computed by the coordinate (x, y, z) and the intensity value I of pixels. The CGH is used in obtaining a 3-dimensional hologram image. The geometry for calculating the Fresnel hologram of an object image is shown in FIG. 1. Although the following description focuses on the CGH, it shall be apparent that the present invention is not restricted to this example.

The hologram is located at an x-y plane 130. Here, the location coordinate of a pth point of the object is specified by (xₚ, yₚ, zₚ) 110, and each object point is assumed to have an associated real-valued magnitude and phase of aₚ and Φₚ, respectively. These are used for the following equation by a computer.

In the hologram, a complex amplitude O(x, y) can be obtained by the superposition of the object beam, as expressed by the following equation 1.

$$O ( x , y ) = {\sum }_{p = 1}^{N} \frac{{a}_{p}}{{r}_{p}} exp [ j ( {kr}_{p} + {φ}_{p} ) ] \qquad ( 1 )$$

Here, p is points (object points) constituting an object, and N is the number of object points. aₚ is the magnitude of the object beam, and k is a frequency vector and defined as k=2π/λ, in which λ is the free space wavelength of the light. rₚ is a sloping distance between the pth point of the object and the point on the hologram plane of (x, y, 0) and is defined by the following equation 2.

$${r}_{p} = \sqrt[2]{{( x - {x}_{p} )}^{2} + {( y - {y}_{p} )}^{2} + {z}_{p}^{2}} \qquad ( 2 )$$

A complex amplitude R(x, y) of the reference beam, which is a plane beam, is expressed by the following equation 3.

R(x, y)=a_{R}exp[j(kx sin θ_{R})] (3)

Here, a_{R} and θ_{R} are the magnitude of the reference beam and the incident angle of the reference beam, respectively. The overall grid intensity I(x, y) of the hologram plane is an interference pattern between the object beam O(x, y) and the reference beam R(x, y) and is expressed by the following equation 4. * means that the phase is opposite.

I(x)=|O+R|²=|O|²+|R|²+2 [symbol] {OR*}² (4)

In the equation 4, a first part |O|² is the intensity of the object wave, and a second part |R|² is the intensity of the reference wave. A third part 2 [symbol] {OR*}² is the interference pattern between the object wave and the reference wave that partially includes hologram information, and includes phase information in accordance with the spatial location of the object wave.

In the following equation 5, the hologram information is included in the third part 2 [symbol] {OR*}² only, and thus the hologram information I(x, y) can be expressed as follows.

$$I ( x , y ) = 2 {{\sum }_{p = 1}}^{N} \frac{{a}_{p}}{{r}_{p}} cos ( {kr}_{p} + kr sin {θ}_{R} + {φ}_{p} ) \qquad ( 5 )$$

In accordance with an embodiment of the present invention, a principal fringe pattern is calculated for a particular point of the target object that is separated by a same distance from the reference point, for example, the point (x, y, 0), of the hologram plane where a hologram pattern is formed. Here, the hologram plane is separated by a particular distance from the target object. The principal fringe pattern generates and records only one pattern for a same depth plane. Accordingly, a hologram pattern can be calculated in real time by shifting the calculated principal fringe pattern to the object points of the target object that exist on the same depth plane. A three dimensional image can be played back by reconstructing the calculated hologram pattern. The technologies for calculating and playing back hologram patterns are generally understood by those with ordinary knowledge in the field of art to which the present invention belongs, so that certain detailed explanations of prior art will be omitted if a certain known related technology is determined to evade the point of the present invention.

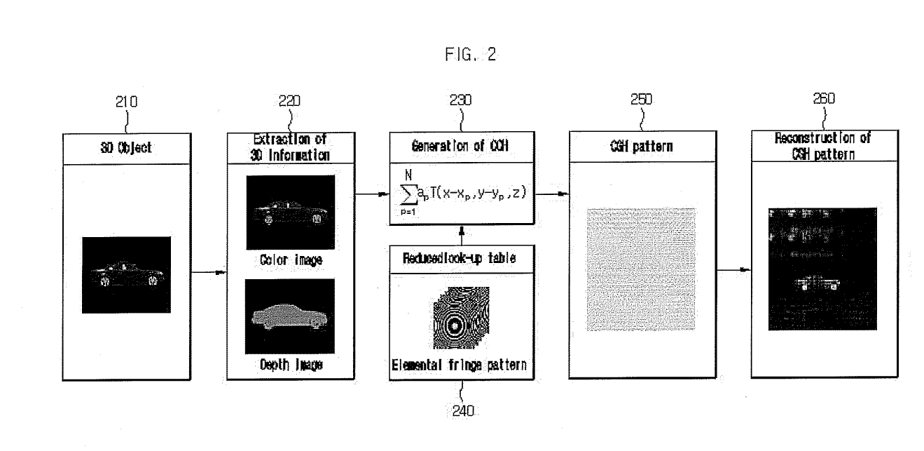

FIG. 2 illustrates an apparatus for calculating a computer generated hologram using a look-up table in accordance with an embodiment of the present invention. Illustrated in FIG. 2 are a 3D object (i.e., a target object) 210, a 3D information extracting unit 220 for extracting 3D information, a CGH generating unit 230 for generating CGH, a look-up table 240 for storing elemental fringe patterns, a CGH pattern 250 and a CGH pattern reconstructing unit 260 for reconstructing CGH patterns. In FIG. 2, effects and functions of each component are mainly described. In the present embodiment, the apparatus can further include a principal fringe pattern calculating unit that calculates the principal fringe pattern described above.

Before describing the components of the present invention, a preconditioned aspect of certain embodiments of the present invention is as follows. Generally, an image space is not separable. However, since the human being's optical system is limited in its ability, the resolution can be selected without compromising the image quality. Here, the degree of separation is small enough not to be recognized by the eyes of a person so that two successively formed points can be recognized as if the two points were not separated from each other. For example, a human recognizes two points having a gap of 3 milliradians as one single point. Accordingly, when an image is viewed from a distance of 500 mm, two points having a gap of 150 microns or less (500 mm×0.003=150 microns) can be recognized as one single point. In an embodiment of the present invention, the degree of horizontal and vertical separation will be set to 150 microns.

The 3D information extracting unit 220 extracts the depth information of the 3D object 210 by extracting a color image and a depth image.

The principal fringe pattern calculating unit calculates a principal fringe pattern for the points of the 3D object that are separated by a same distance from a reference point of the hologram plane. The principal fringe pattern is stored in the look-up table 240, depending on the distance between the reference point and each point of the 3D object.

The fringe patterns of the look-up table 240 can be calculated by the equation 5 described above. That is, the fringe pattern T having reference intensity is expressed as follows.

$$T ( x , y , {x}_{p} , {y}_{p} , {z}_{p} ) = \frac{1}{{r}_{p}} cos [ {kr}_{p} + kx sin {θ}_{R} + {Φ}_{p} ] \qquad ( 6 )$$

In accordance with an embodiment of the present invention, a hologram is not calculated by calculating the fringe pattern of each point whenever it is required, like the equation 5, but the hologram is calculated by using the pre-made look-up table, which is a set of fringe patterns for corresponding points. Accordingly, the hologram information I is expressed as follows.

$$I ( x , y ) = {\sum }_{p = 1}^{N} {a}_{p} T ( x , y , {x}_{p} , {y}_{p} , {z}_{p} ) \qquad ( 7 )$$

Here, N is the number of object points constituting the 3D object.

The conventional look-up table (LUT) method has brought a tremendous increase in speed by using precalculated fringe patterns. However, the biggest drawback of this method is that the number of precalculated fringe patterns is too many so that the memory capacity of the LUT, which stores the precalculated fringe patterns, will increase dramatically. For example, if it is assumed that, in the LUT method, an object space is 100 (width)×100 (height)×100 (depth), and the memory capacity of each fringe pattern is 1 MB, the memory capacity of the entire look-up table may require 1 MB×100×100×100=1 TB.

Accordingly, in the present embodiment, a look-up table that only includes one principal fringe pattern for each depth plane in order to reduce the capacity of the conventional look-up table is provided.

The CGH generating unit 230 calculates computer-generated hologram information by shifting the principal fringe pattern from the reference point to those points of the 3D object 210 on each depth plane. Here, the CGH information is as follows. The CGH information represents the CGH pattern 250.

$$I ( x , y ) = {\sum }_{p = 1}^{N} {a}_{p} T ( x - {x}_{p} , y - {y}_{p} , {z}_{p} ) \qquad ( 8 )$$

Here, I is the computer-generated hologram information, aₚ is an intensity value of the object beam of the pth point of the 3D object, and N is the number of points of the 3D object.

The CGH pattern reconstructing unit 260 plays back a three dimensional image by reconstructing the CGH pattern 250.

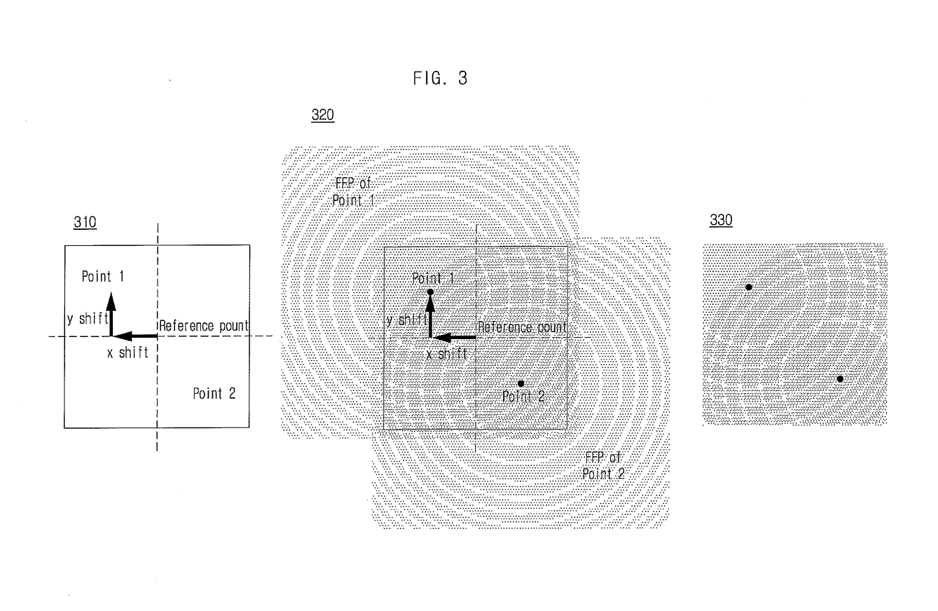

FIG. 3 illustrates a hologram pattern formed by shifting a reference fringe pattern in accordance with an embodiment of the present invention. Illustrated in FIG. 3 are an input image 310, a combined image 320 of the shifted principal fringe pattern and a CGH pattern 330.

Referring to FIG. 3, there are two point light sources in the input image 310. If one point light source is located at the plane of (−xₚ, yₚ) from the point that is used to calculate the principal fringe pattern, the principal fringe pattern is shifted from the point to the x and y directions by −xp and yp, respectively. After performing the above process to all possible points on that particular depth plane, the shifted fringe patterns are combined together. The combined image 320 of the shifted principal fringe pattern briefly illustrates how the shafted fringe patterns are combined to form a computer-generated pattern. Also, the finally generated pattern is illustrated in the CGH pattern 330.

As described above, in the present embodiment, the degree of horizontal and vertical separation is set to 150 microns. Accordingly, if it is assumed that the pixel size of the hologram is 10 μm, 15 pixels need to be moved for displacement by 150 μm. Here, if the size of the principal fringe pattern is too small, the principal fringe pattern may not be enough to fill the predetermined size of the hologram. To avoid this situation, the size of the principal fringe pattern needs to be somewhat increased. Nevertheless, if the size of the principal fringe pattern becomes bigger, the file size also becomes bigger. Accordingly, the principal fringe pattern needs to be sized properly.

Here, if it is assumed that one depth plane is constituted by points of 100×100 and the pixel size of the hologram is 10 μm, the principal fringe pattern needs to be moved to the x and y directions by 100×15 pixels=1,500 pixels, respectively, in order to express all possible points of the depth plane: Specifically, if the size of the hologram pattern is 256×256, the overall size of the principal fringe pattern becomes 1,756 (256+1,500)×1,756 (256+1,500).

Hitherto, the typical configuration of a computer-generated hologram calculating apparatus and a method for calculating a computer-generated hologram have been described. Hereinafter, a method of calculating a computer-generated hologram using a look-up table in accordance with an embodiment of the present invention and an apparatus thereof will be described in more detail with reference to the accompanying drawings. It shall be obvious, however, that the present invention is not restricted to this embodiment.

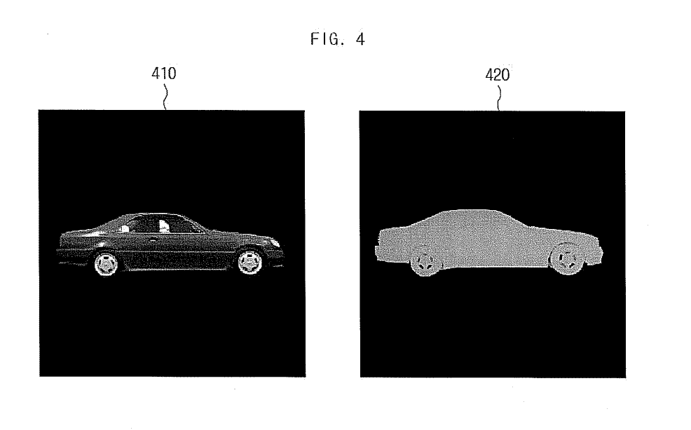

FIG. 4 illustrates an input image and a depth image used for a method of calculating a computer generated hologram using a look-up table in accordance with an embodiment of the present invention.

In the present embodiment, an input image 410 used in the experiment is an image of a car. Here, the input image 410 is for processing information by inputting a 3D object to a computer. A depth image 420 is an image that expresses the input image 410 in accordance with the depth information. Each image has the resolution of 100×100, and the size of the hologram is 256×256. The three-dimensional information of the 3D object is obtained by combining the input image 410 and the depth image 420 together. The points on a same depth plane are arranged in a depth direction in order to calculate one principal fringe pattern.

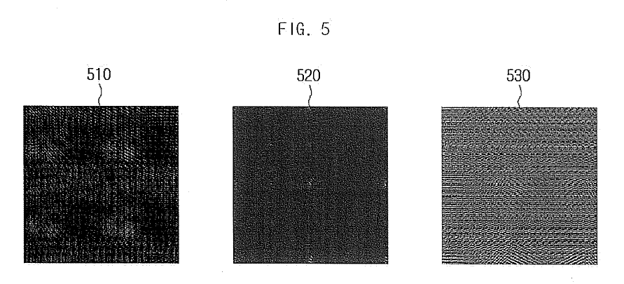

FIG. 5 compares a hologram pattern in accordance with an embodiment of the present invention and a hologram pattern in accordance with the related art. Illustrated in FIG. 5 are a hologram pattern 510, which is calculated by the conventional diffraction based method (traditional method), a hologram pattern 520, which is calculated by the conventional LUT method, and a hologram pattern 530, which is calculated by the reduced LUT method in accordance with an embodiment of the present invention.

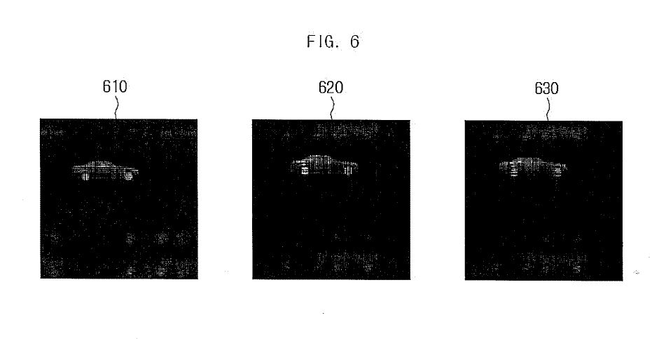

FIG. 6 illustrates digitally reconstructed images of the images shown in FIG. 5. Illustrated in FIG. 6 are an image 610, which is reconstructed by the conventional diffraction based method, an image 620, which is reconstructed by the conventional LUT method, and an image 630, which is reconstructed by the reduced LUT method in accordance with an embodiment of the present invention. It can be seen that the three images 610, 620 and 630 show a clear picture of the car.

In the following Table, the three method for calculating a hologram, which have been described above, are compared in terms of average computation time for one object point and memory used for a look-up table.

| | Conventional | Conventional | Reduced |
|---|---|---|---|
| | diffraction | look- | look-up |
| | method | up table method | table method |
| Average | 959.4702 | 11.0539 | 19.6958 |
| computation time for | | | |
| one object point (ms) | | | |
| Memory used for | | 64 GB | 295 MB |
| look-up table | | | |

In the present embodiment, a personal computer and Matlab 6.5 were used for the experiment. The computation time shown in the above Table is average computation time for calculating a hologram for one object point. That is, the conventional diffraction based method requires 959.5 ms to calculate a hologram for one object point, and the conventional LUT method requires 11.1 ms to calculate a hologram for one object point while the reduced LUT method of the present invention requires 19.7 ms to calculate a hologram for one object point. Accordingly, as it can be seen through the Table, the conventional LUT method using a look-up table provides 86.8 times faster computing speed than the conventional diffraction based method, and the proposed LUT method provides 48.7 times faster computing speed than the conventional diffraction based method.

It can be seen that these speed improvements can be obtained by simple calculations with reference to the equations 1 to 5 described above. Specifically, in the conventional diffraction based method, at least six additions, seven multiplications, one division, one square root and two trigonometric functions need to be done in order to calculate a hologram pattern.

In the proposed reduced LUT based method, however, only at least one multiplication and one addition need to be done for calculating a hologram pattern.

For the memory capacity of the LUT, the conventional LUT method requires 64 GB in order to store fringe patterns while the proposed LUT method in accordance with an embodiment of the present invention requires 295 MB only.

For example, it shall be assumed that an image space is 100 (width)×100 (height)×100 (depth), and the size of a hologram is 256×256. In the conventional LUT method, 1,000,000 fringe patterns (that is, 100×100×100=1,000,000) are required, and the size of each fringe pattern is 256×256. Accordingly, the memory size of one fringe pattern becomes 256×256×8 bit=64 KB, and the overall memory size of the LUT becomes 64 KB×1,000,000=64 GB. On the other hand, the size of the principal fringe pattern in accordance with an embodiment of the present invention is 1,756×1,756, as described above. Also, the memory size of one principal fringe pattern becomes 1,756×1,756×8 bit=2.95 MB, which is bigger than that of the conventional LUT method. However, the reduced LUT method of the present invention requires 100 principal fringe patterns only, and thus the overall memory size of the LUT becomes 2.95 MB×100=295 MB.

Accordingly, although the principal fringe pattern, of which the size is 2.95 MB, of the proposed LUT method is 46.1 times bigger than that of the conventional LUT method, the proposed LUT method only requires the image space of 1/217, compared to that of the conventional LUT method.

The method for calculating a computer-generated hologram using a look-up table in accordance with an embodiment of the present invention can be performed by a device, for example, a mobile communication terminal, after the method is stored in a storage medium. Here, the storage medium can be a magnetic or optically readable storage medium, for example, a hard disk, a video tape, CD, VCD and DVD, or a database of a client or sever computer that is built on off-line or on-line.

While the spirit of the invention has been described in detail with reference to a certain embodiment, the embodiment is for illustrative purposes only and shall not limit the invention. It is to be appreciated that those skilled in the art can change or modify the embodiment without departing from the scope and spirit of the invention.

What is claimed is:

1. A method of calculating a hologram using a look-up table by a computer-generated hologram calculating apparatus, the method comprising:
calculating one principal fringe pattern for points of a target object that are separated by a same distance from a reference point of a hologram plane;
writing the principal fringe pattern in the look-up table in accordance with a distance between the points of the target object and the reference point;
calculating computer-generated hologram information by shifting the principal fringe pattern to the points of the target object located on a same plane; and
playing back a three-dimensional image by using the computer-generated hologram information.

2. The method of claim 1, wherein the principal fringe pattern is calculated by using the following equation,
$$T ( x , y , {x}_{p} , {y}_{p} , {z}_{p} ) ≡ \frac{1}{{r}_{p}} cos [ {kr}_{p} + kx sin {θ}_{R} + {φ}_{p} ]$$
whereas, T is the principal fringe pattern, (xp, yp, zp) is a coordinate of a pth point of the target object, rₚ is a distance between the pth point of the target object and the reference point (x, y, 0), k is defined as k=2π/λ, in which λ is the free space wavelength of the light, θ_{R} is an angle between a reference beam and an object beam, and Φₚ is a phase value of an object beam of the pth point of the target object.

3. The method of claim 2, wherein the computer-generated hologram information is calculated by using the following equation,
$$I ( x , y ) = {\sum }_{p = 1}^{N} {a}_{p} T ( x - {x}_{p} , y - {y}_{p} , {z}_{p} )$$
whereas, I is the computer-generated hologram information, aₚ is an intensity value of the object beam of the pth point of the target object, and N is the number of points of the target object.

4. A computer-generated hologram calculating apparatus using a look-up table, the apparatus comprising:
a principal fringe pattern calculating unit configured to calculate one principal fringe pattern for points of a target object that are separated by a same distance from a reference point of a hologram plane;
a look-up table configured to write the principal fringe pattern in the look-up table in accordance with a distance between the points of the target object and the reference point;
a CGH generating unit configured to calculate computer-generated hologram information by shifting the principal fringe pattern to the points of the target object located on a same plane; and
a CGH pattern reconstructing unit configured to play back a three-dimensional image by using the computer-generated hologram information.

5. The apparatus of claim 4, wherein the principal fringe pattern is calculated by using the following equation,
$$T ( x , y , {x}_{p} , {y}_{p} , {z}_{p} ) ≡ \frac{1}{{r}_{p}} cos [ {kr}_{p} + kx sin {θ}_{R} + {φ}_{p} ]$$
whereas, T is the principal fringe pattern, (xp, yp, zp) is a coordinate of a pth point of the target object, rₚ is a distance between the pth point of the target object and the reference point (x, y, 0), k is defined as k=2π/λ, in which λ is the free space wavelength of the light, θ_{R} is an angle between a reference beam and an object beam, and Φₚ is a phase value of an object beam of the pth point of the target object.

6. The apparatus of claim 5, wherein the computer-generated hologram information is calculated by using the following equation,
$$I ( x , y ) = {\sum }_{p = 1}^{N} {a}_{p} T ( x - {x}_{p} , y - {y}_{p} , {z}_{p} )$$
whereas, I is the computer-generated hologram information, aₚ is an intensity value of the object beam of the pth point of the target object, and N is the number of points of the target object.
